(19) United States
(12) Patent Application Publication
(10) Pub. No.: US 2007/0007880 A1
(43) Pub. Date: Jan. 11, 2007

(54) Flat illuminating apparatus

(75) Inventors: Jer Shien Yang, Sinjhuang City (TW); Kuo Chih Yang, Hsinchu City (TW); Jui Hsia Chen, Hsinchu City (TW); Shih Yuan Huang, Longjing Township (TW); Yui Shin Fran, Hsinchu City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: DELTA OPTOELECTRONICS, INC., Hsin-Chu (TW)

(21) Appl. No.: 11/477,337

(22) Filed: Jun. 28, 2006

(30) Foreign Application Priority Data
Jun. 28, 2005 (TW) 94121717

(51) Int. Cl. H01J 63/04

(52) U.S. Cl. 313/496

(57) ABSTRACT

An illuminating apparatus is provided. The illuminating apparatus comprises a lower plate, an upper plate opposing to the lower plate to form a containing space therebetween, a supporting structure mounted within the containing space and connected with the lower plate and the upper plate, and a buffer material connected with at least one of the lower plate, the upper plate and the supporting structure.

### FIELD OF THE INVENTION

The present invention relates to a flat illuminating apparatus, and more particularly to a flat illuminating apparatus as the backlight for a liquid crystal display device.

### BACKGROUND OF THE INVENTION

Due to the advanced technology, the flat panel display has gradually replaced the traditional cathode ray tube to become the mainstream in the market owing to its superior in space-saving. With regard to the liquid crystal display, one kind of flat panel display, the liquid crystal exhibits luminescence through backlight sources transmitting the liquid crystal layers instead of self-emitting. Therefore, it comes up with the cold cathode fluorescent lamp disposed behind the liquid crystal display as the backlight source.

However, a circular cross section of the lamp tube indicates that light radiates outwards from the center of a circle such that quantities of transmitting light received by each spot in the liquid crystal display panel are different owning to the different distances between each spot in the display panel and the lamp tube. In other words, the longer distance away from the panel display, the lower quantities of light are received. Therefore, the disposition of the cold cathode fluorescent lamp results in uneven illumination. Besides, multiple lamp tubes are used to improve the above drawbacks, and a structure for evenly spreading light is also needed, such as a diffuser, a freni lens, or the combination thereof. Nevertheless, the above-mentioned structures make the overall display device much thicker since the path length is prolonged for mixing transmitted light, and the distance between each spot in the display panel and the lamp tube is equalized. Therefore, the superior in space-saving of the liquid crystal display is vanished by these structures.

In addition, another severe issue lies in that the efficiency of the cold cathode fluorescent lamp declines when used for a long time, and each lamp declines at a different rate. Therefore, the uneven backlight resulting from each lamp declining at a different rate brings about the inconvenience for consumers.

Consequently, a flat illuminating apparatus is invented and used as the backlight for the liquid crystal display for solving the above-mentioned drawbacks. The flat illuminating apparatus is radiated by glowing discharge, which is driven by the different pressure inside and outside the flat illuminating apparatus. In order to resist the stress caused by different pressures between the inside and outside of the illuminating apparatus, the material of small-scale area in the flat illuminating apparatus is only made of tempered glass or other better one, but that of large-scale area in the flat illuminating apparatus resists the stress by the structural design instead of relying on the material.

Therefore, in the flat illuminating apparatus field, a flat illuminating apparatus structure is extremely essential for effectively resisting the outside pressure to increase the area of the flat illuminating apparatus.

From the above description, it is known that how to develop a better flat illuminating apparatus has become a major problem to be solved. In order to overcome the drawbacks in the prior art, an improved flat illuminating apparatus is provided. The particular design in the present invention not only solves the problems described above, but also is easy to be implemented. Thus, the invention has the utility for the industry.

### SUMMARY OF THE INVENTION

It is an aspect of the present invention to provide a flat illuminating apparatus. The flat illuminating apparatus comprises a lower plate, an upper plate, a supporting structure and a buffer material. The upper plate is mounted opposing to the lower plate to form a containing space therebetween. The supporting structure is mounted within the containing space and connected with the upper and the lower plates. The buffer material is connected with at least one of the lower plate, the upper plate and the supporting structure. Moreover, the buffer material is formed between the supporting structure and the lower plate.

As the above illuminating apparatus, the buffer material is further formed between the supporting structure and the upper plate to absorb an external force applied to the upper plate.

As the above illuminating apparatus, a frame is further used to rim the containing space so that the containing space is sealed by the upper plate, the lower plate and the frame.

As the above illuminating apparatus, the buffer material is further formed between the frame and the upper plate and between the frame and the lower plate.

Furthermore, a first electrode set is further connected with the lower plate and comprises a first subsidiary electrode, a second subsidiary electrode and a first spacing therebetween. A second electrode set is also further connected with the lower plate and comprises a third subsidiary electrode, a fourth subsidiary electrode and a second spacing therebetween, where the supporting structure is formed respectively within the first and second spacing.

Moreover, a first electrode and a second electrode are respectively connected with the lower plate that forms a discharging zone and a non-discharging zone. The supporting structure is mounted in the non-discharging zone, and the discharging zone has a discharging direction.

Besides, the first electrode further comprises a first discharging part and a first conductive part. The second electrode comprises a second discharging part mounted corresponding to the first discharging part and a second conductive part mounted corresponding to the first conductive part. The discharging zone is formed by the first discharging part and the second discharging part, and the non-discharging zone is formed by the first conductive part corresponding with the second conductive part.

According to the illuminating apparatus of the present invention, the supporting structure is a rectangular cylinder having a long side and a short side, and the long side is mounted along the discharging direction of the discharging zone.

Preferably, a first electrode and a second electrode are respectively connected with the lower plate, wherein the supporting structure is mounted respectively in the first and second electrodes.

According to the illuminating apparatus of the present invention, the first electrode comprises a first discharging part and a first conductive part. The supporting structure is further mounted within the first conductive part. The same as the second electrode, the supporting structure is also further mounted within the second conductive part.

According to the illuminating apparatus of the present invention, the supporting structure tends to become gradually narrow along the direction from the lower plate to the upper plate.

According to the illuminating apparatus of the present invention, the supporting structure has a flat bottom and a cylinder is formed onto the flat bottom.

The present invention further provides a method for manufacturing a flat illuminating apparatus. The method comprises following steps of: (1) providing a lower plate and an upper plate; (2) forming a layer of fluorescent material on the respective lower and upper plates; (3) mounting a supporting structure between the upper plate and the lower plate; (4) forming a buffer material connected to at least one of the upper plate, the lower plate and the supporting structure; (5) solidifying the buffer material; and (6) combining the upper plate, the supporting structure and the lower plate.

According to the method of the present invention, a step of pressing the supporting structure is further comprised.

According to the method of the present invention, a step of mounting a frame between one of the upper and the lower plates is further comprised.

According to the method of the present invention, the supporting structure has a long side mounted perpendicular to the lower plate.

According to the method of the present invention, the layer of fluorescent material is performed by one selected from the group consisting of coating, printing, and depositing.

According to the method of the present invention, the coating is one selected from the group consisting of dip coating, roll coating, and spray coating.

According to the method of the present invention, the buffer material is performed by coating and printing.

According to the method of the present invention, a first predetermined area is further reserved without the layer of fluorescent material on the lower plate in the step (2), and the buffer material of the step (4) is formed on the first predetermined area.

According to the method of the present invention, the step (3) further comprises a step of coating the buffer material between the upper plate and the supporting structure.

According to the method of the present invention, a second predetermined area is further reserved without the layer of fluorescent material on the upper plate in the step (2), and the layer of buffer material is coated on the second predetermined area

According to the method of the present invention, a step of solidifying the layer of buffer material between the upper plate and the supporting structure is further included.

The above aspects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a lateral cross-section view of the flat illuminating apparatus according to a first embodiment of the present invention;

FIG. 2 is a lateral cross-section view of the flat illuminating apparatus according to a second embodiment of the present invention;

FIG. 3 is a vertical view of the position of the protecting structure according to a first embodiment of the present invention;

FIG. 4 is a vertical view of the position of the protecting structure according to a second embodiment of the present invention;

FIG. 5 is a vertical view of the position of the protecting structure according to a third embodiment of the present invention;

FIG. 6 is a vertical view of the position of the protecting structure according to a fourth embodiment of the present invention;

FIG. 7 is a lateral view of the protecting structure according to a first embodiment of the present invention;

FIG. 8 is a lateral view of the protecting structure according to a second embodiment of the present invention;

FIG. 9 is a schematic diagram of the method for manufacturing the flat illuminating apparatus according to a preferred embodiment of the present invention;

FIG. 10 is a schematic diagram of the method for manufacturing the flat illuminating apparatus according to another preferred embodiment of the present invention;

FIG. 11 is a schematic diagram of the method for manufacturing the flat illuminating apparatus according to a further preferred embodiment of the present invention;

FIG. 12 is a diagram of the protecting structure of the flat illuminating apparatus according to a preferred embodiment of the present invention;

FIG. 13 is a diagram of the protecting structure of the flat illuminating apparatus according to another preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

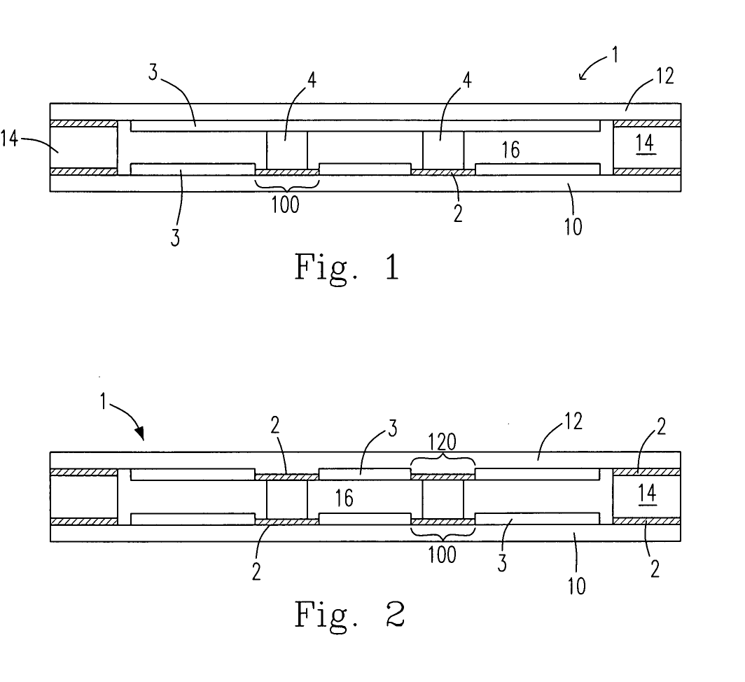

Please refer to FIG. 1, which shows a lateral cross-section view of the flat illuminating apparatus according to a first embodiment of the present invention. The flat illuminating apparatus 1 comprises a lower plate 10 where the fluorescence material 3 is formed thereon and an upper plate 12. A containing space 16 is formed between the lower plate 10 and the upper plate 12. A supporting structure 4 is mounted within the containing space 16 and connected with the upper plate 12 and the lower plate 10. In the flat illuminating apparatus 1 of the present invention, one special feature lies in a buffer material 2 mounted between the supporting structure 4 and the lower plate 10. The buffer material 2 is used for buffering the stresses driven by the flexible distance between the supporting structure 4 and the lower plate 10. Actually, the real distance between the supporting structure 4 and the lower plate 10 is uncertain during the process of manufacturing the flat illuminating apparatus, and hence the plasticity of the buffer material 2 is used to mediate and reduce the impact driven by the changeable distance between the supporting structure 4 and the lower plate 10. While the distance between the supporting structure 4 and the lower plate 10 is shortened by external forces, the buffer material 2 is pressed out and overflowed outwards. On the other hand, while the distance is extended between the supporting structure 4 and the lower plate 10, the buffer material 2 is prolonged.

In addition, as illustrated in FIG. 1, the fluorescent material 3 is formed in the inside surface of the upper plate 12 for radiation since the fluorescence material 3 is illuminated by ultraviolet light produced by glowing discharge of the inert gas in the containing space 16. A frame 14 is mounted around the upper plate 12 and the lower plate 10 and supports the overall structure of the flat illuminating apparatus 1, which serves as a sidewall of the containing space 16. Furthermore, in order to make the supporting structure 4 and the lower plate 10 more stable, a first predetermined area 100 is reserved to accommodate the buffer material 2 which directly contacts the lower plate 10 when the fluorescent material 3 is formed by coating, printing, or depositing. Therefore, through the buffer material 2, the location of the supporting structure 4 is assured and a malposition by external forces would not occur in the flat illuminating apparatus 1, thereby stabilizing the supporting structure 4 and the lower plate 10. Additionally, the frame 14 is used to connect the lower plate 10 and the upper plate 12 by the buffer material 2.

Please refer to FIG. 2, which shows a lateral cross-section view of the flat illuminating apparatus according to a second embodiment of the present invention. The supporting structure 4 is only fastened with the lower plate 10 by the buffer material 2 as illustrated in FIG. 1, and hence the supporting structure 4 is still possible to produce a relative malposition with the lower plate 12. In order to avoid the side effect caused by the relative malposition, such as collision therebetween, and reduce the tolerance during the manufacturing process of the flat illuminating apparatus, the buffer material 2 is also formed between the supporting structure 4 and the upper plate 12. The buffer material 2 achieves the fixation, mediation, and buffering effect. Therefore, the resident stress between the supporting structure 4 and the upper plate 12 may be absorbed, mediated, and buffered through the buffer material 2 during the process of manufacturing the flat illuminating apparatus 1. The upper plate 10 can be in balance with the lower plate 12 in structure since all external factors can be mediated by the buffer material 2 after the flat illuminating apparatus 1 is made.

Please refer to FIGS. 1 and 2, any predetermined area is unnecessary to reserve on the upper plate 12 for the buffer material 2 while the fluorescent material 3 is formed on the upper plate 12. In other words, the buffer material 2 is directly formed on the fluorescent material 3. However, in order to enhance the fixation between the supporting structure 4 and the upper plate 12, a second predetermined area 120 is reserved, enabling the buffer material 2 to be directly contacted with the upper plate 12 while the fluorescent material 3 is mounted on the upper plate 12 so as to fix each other.

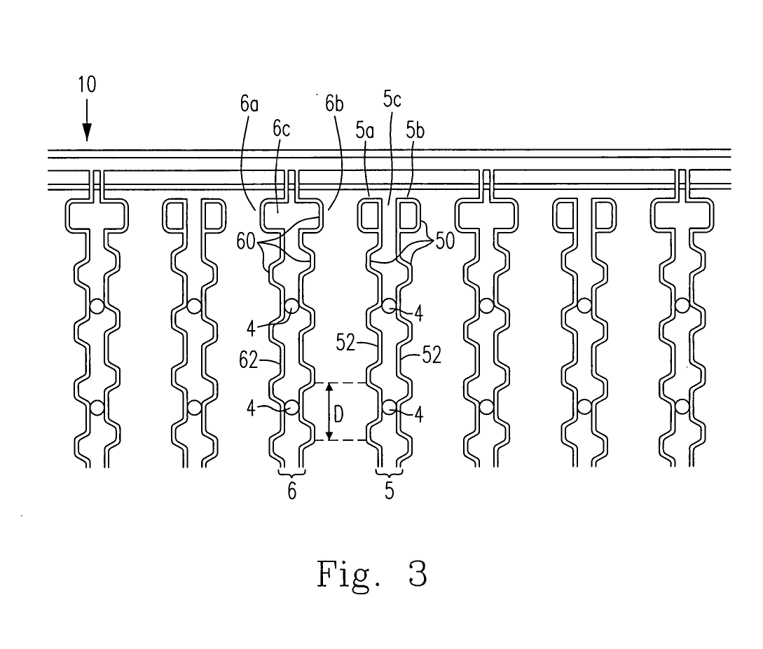

Please refer to FIG. 3, which shows a vertical view of the position of the protecting structure according to a first embodiment of the present invention. The lower plate 10 comprises a first electrode set 5 mounted thereon. The first electrode set 5 further comprises a first subsidiary electrode 5a, a second subsidiary electrode 5b, and a first spacing 5c therebetween. The lower plate 10 comprises a second electrode set 6 mounted thereon. The second electrode set 6 further comprises a third subsidiary electrode 6a, a fourth subsidiary electrode 6b and a second spacing 6c therebetween. The supporting structure 4 is mounted respectively within the first spacing 5c and the second spacing 6c.

In such way, the space between the first subsidiary electrode 5a and the second subsidiary 5b dose not cause discharge due to the same polarity within the first electrode set 5, which is an ideal position to mount the supporting structure 4. The same is applied in the second electrode set 6.

Please refer to FIG. 3 again, wherein the first subsidiary electrode 5a and the second subsidiary electrode 5b further comprise a first discharging part 50 and a first conductive part 52. Correspondingly, the third subsidiary electrode 6a and the fourth subsidiary electrode 6b also further comprise a second discharging part 60 and a second conductive part 62. As for the reverse polarities of the first electrode set 5 and the second electrode set 6, the discharging part is defined because the shorter distance between the discharging parts of electrodes than the conductive parts of electrodes triggers discharge. Furthermore, a distance D is defined as the distance of each adjacent discharging part. The distance D is not changed by the position and shape of the supporting structure 4.

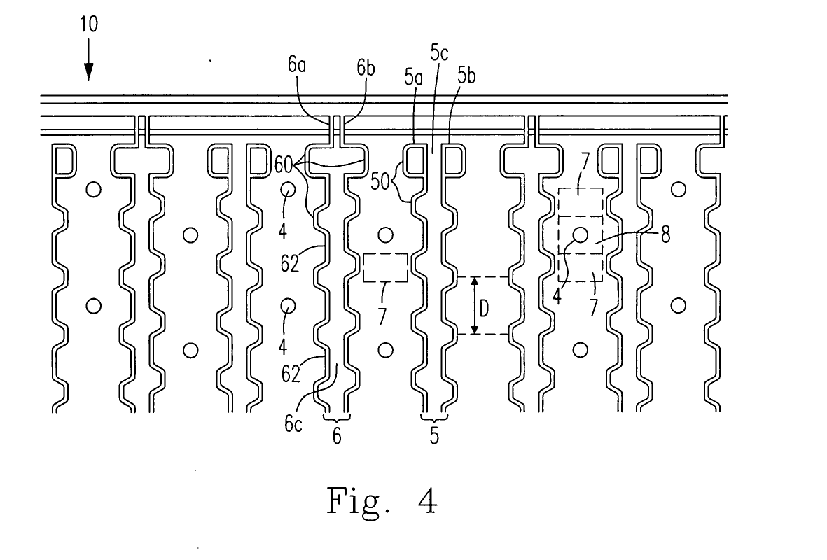

Please refer to FIG. 4, which shows a vertical view of the position of the protecting structure according to a second embodiment of the present invention. All the structural elements in FIG. 4 are the same as those in FIG. 3, except the position of the supporting structure. A plurality of discharging zones 7 are triggered to form within the discharging part 50 and the discharging part 60, and a plurality of non-discharging zones 8 are defined between the adjacent discharging zones 7. The embodiment in FIG. 4 shows that the supporting structure 4 is mounted within the non-discharging zone 8 rather than respectively within the first spacing 5c and the second spacing 6c in FIG. 3. Therefore, the supporting structure 4 mounted within the non-discharging zone 8 will not interfere with the discharge in the discharging zone 8. In other words, the position of the supporting structure 4 is devised to be mounted in the area except the discharging zone 7, which comprises the non-discharging zone 8 and further comprises the first space 5c and the second space 6c as illustrated in FIG. 3.

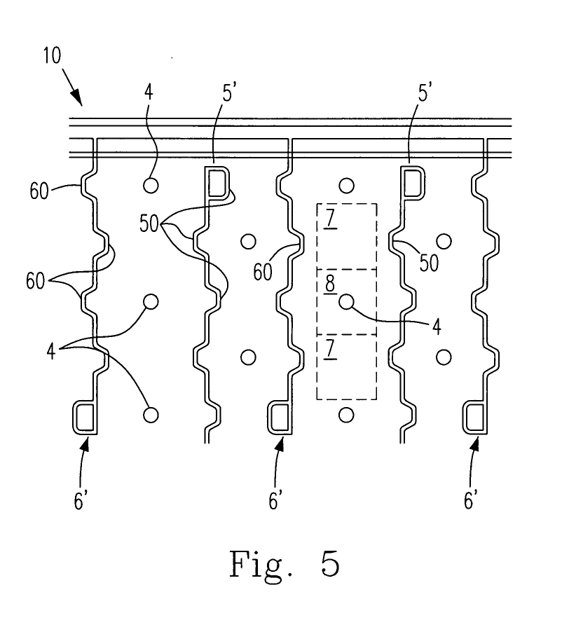

Please refer to FIG. 5, which shows a vertical view of the position of the protecting structure according to a third embodiment of the present invention. A first electrode 5′ and a second electrode 6′ are mounted on the lower plate 10. The first electrode 5′ further comprises a first discharging part 50 and a first conductive part 52 (not shown in FIG. 5). The second electrode 6′ further comprises a second discharging part 60 and a second conductive part 62 (not shown in FIG. 5). The embodiment of the present invention in FIG. 5 illustrates that there is only single electrode rather than duplicate electrodes of the electrode set in FIGS. 3 and 4. Moreover, there is no spacing as shown in FIG. 5. Therefore, the supporting structure 4 is mounted in the non-discharging zone 8 between the adjacent discharging zones 7 which is triggered between the first discharging part 50 and the second discharging part 60 in the structure of the embodiment illustrated in FIG. 5.

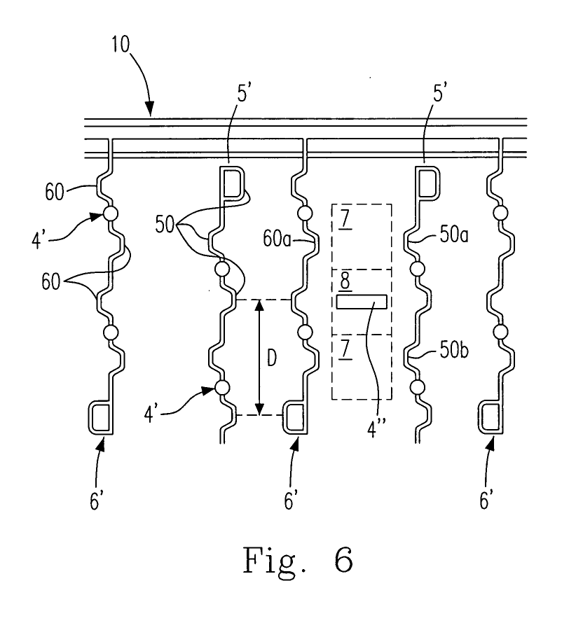

Please refer to FIG. 6, which shows a vertical view of the position of the protecting structure according to a fourth embodiment of the present invention. This embodiment affords an alternative position where the supporting structure 4 is mounted. The supporting structure 4 is mounted in the first electrode 5′ and the second electrode 6′, and the distance D, which is the distance of the adjacent discharging parts 7, is not changed by the position and shape of the supporting structure 4.

Please refer to FIG. 6 again, which shows a rectangular-section supporting structure 4. The position of the supporting structure 4 is the same as that in FIG. 4. In addition, the long side of the rectangular supporting structure 4 is parallel to the respective discharging directions of a first discharging part 50a and a second discharging part 60a. One advantage of the rectangular supporting structure 4 is that the strength could be enhanced by increasing the intercept surface area. Although the distance between the discharging part 50a and the second discharging part 60a is shortest, the second discharging part 60a may be conducted with the first discharging part 50b, which causes an uneven distribution of the discharging zone 7 and thus an uneven radiation, in the condition of small-area or high-density electrode of the illuminating apparatus. Therefore, the intercept surface area of the supporting structure 4 is devised to be rectangular to avoid the above-mentioned phenomenon. Another advantage is that the supporting structure 4 is like a wall between the second discharging part 60a and the first discharging part 50b for blocking the electricity. This arrangement has a dominant effect on even illumination. Furthermore, the supporting structure 4″ in FIG. 6 may also be applied in the embodiments of FIGS. 3, 4 and 5.

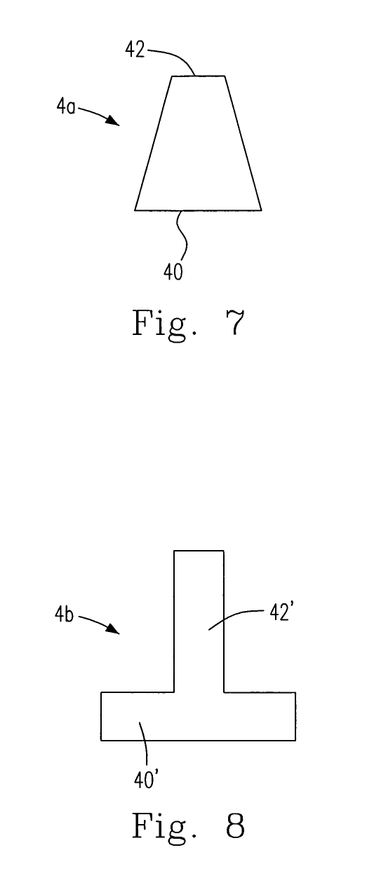

Please refer to FIG. 7, which shows a lateral view of the protecting structure according to a first embodiment of the present invention. The supporting structure 4a comprises a lower end 40 and an upper end 42. The lower end 40 is connected with the lower plate 10, and the upper end 42 is connected with the upper plate 12. The intercept surface area of the supporting structure 4a becomes gradually narrow from the lower end 40 to the upper end 42. The portion of the upper end 42 contacted with the upper plate 42 will block or reduce the fluorescent material 3 radiated by the ultraviolet, and hence the upper plate 12 occupied by the supporting structure 4a is incapable of radiating. The intercept surface area of the upper end 42 is smaller than that of the lower end 40, so that the area of the upper plate 12 occupied by the upper end 42 is reduced to the lowest such that the illuminating area of the upper plate 12 is not affected.

Please refer to FIG. 8, which shows a lateral view of the protecting structure according to a second embodiment of the present invention. The supporting structure 4b comprises a bottom 40′ and a cylinder 42′, wherein the bottom 40′ is flat and the cylinder 42′ is mounted onto the flat bottom 40′. In this way, the intercept surface area of the cylinder 42′, the area of the upper plate 12 contacted with the supporting structure 4b, can be reduced to the lowest so that the influence of the supporting structure 4b on the radiation by the upper plate 12 is decreased.

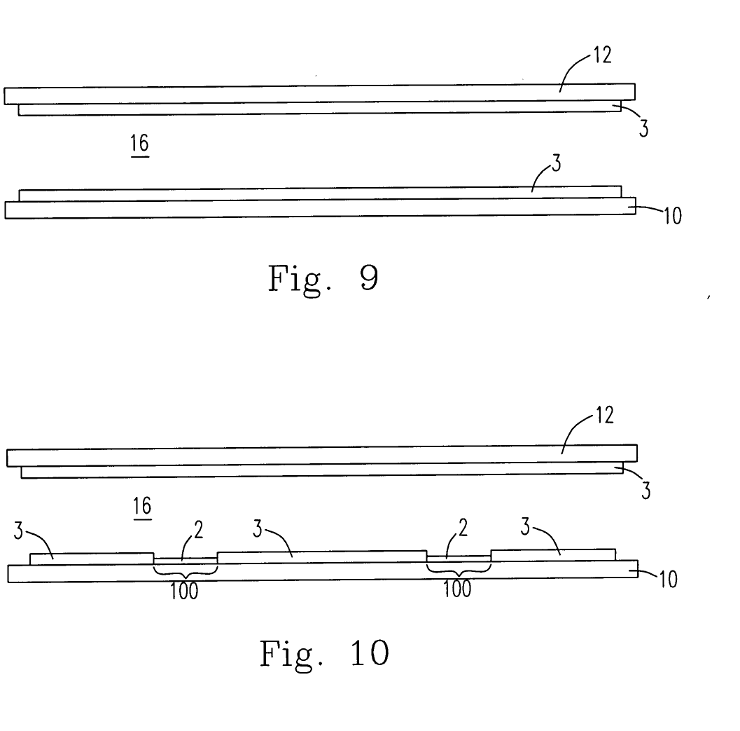

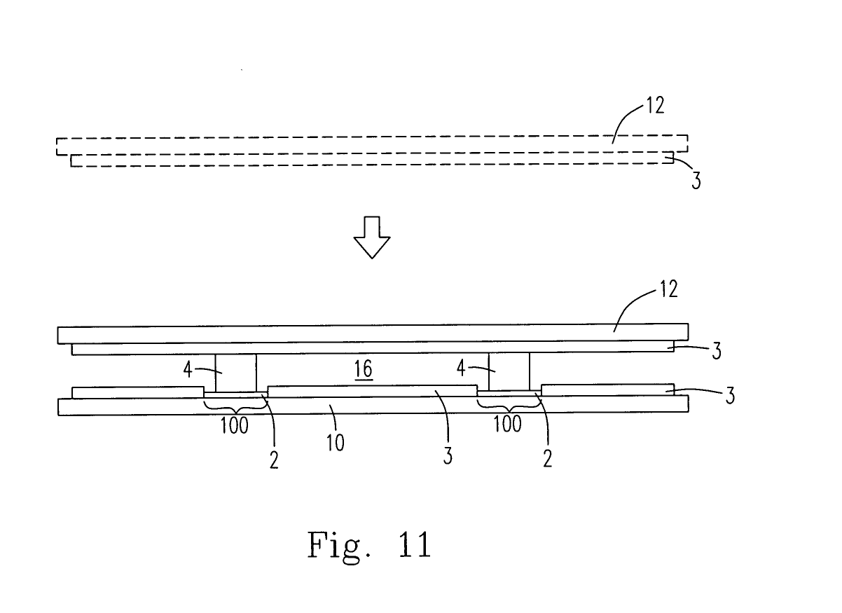

Please to refer to FIGS. 9-11. The present invention provides a method for manufacturing an illuminating apparatus. As illustrated in FIG. 9, the method comprises the following steps. At first, a lower plate 10 and an upper plate 12 are provided, and a containing space 16 is formed therebetween. Then, a fluorescent material 3 is formed on the lower plate 10 and the upper plate 12, as illustrated in FIG. 10. Next, a supporting structure 4 is mounted between the upper plate 12 and the lower plate 10, as illustrated in FIG. 11. Subsequently, a buffer material 2 is formed for being connected to at least one of the upper plate 12, the lower plate 10 and the supporting structure 4. After that, the buffer material 2 is solidified. Finally, the upper plate 12, the supporting structure 4 and the lower plate 10 are combined to accomplish an illuminating apparatus.

Furthermore, one step of pressing the supporting structure 4 is further comprised and followed by the step of forming a buffer material 2 connected to at least one of the upper plate 12, the lower plate 10 and the supporting structure 4. The purpose thereof is to increase the stickiness of the buffer material 2 with the lower plate 10 and the supporting structure 4 by pressing the supporting structure 4 to vanish the space therebetween and squeeze out the extraordinary air.

Besides, the method further comprises a step of mounting a frame 14 between the lower plate 10 and the upper plate 12 to seal an intact and closed containing space.

Moreover, the supporting structure 4 has a long side and a short side. In the step of mounting a supporting structure 4 between the upper plate 12 and the lower plate 10, the long side of the supporting structure 4 is mounted perpendicular to the lower plate 10 and standing thereon.

As for the step of forming a fluorescent material 3 on the lower plate 10 and the upper plate 12, the method of forming the fluorescent layer 3 is one selected from the group consisting of coating, printing, and depositing. With regard to the illuminating apparatus with different area, volume, and usage, the suitable way to form the fluorescent layer 3 is selected correspondingly. Furthermore, the coating can be one selected from the group consisting of dip coating, roll coating, and spray coating.

While the fluorescent layer 3 is mounted on the lower plate 10, the predetermined area 100 on the lower plate 10 is reserved without the fluorescent layer 3 so that the buffer material 2 is mounted thereon directly and the stickiness therebetween is enhanced.

Further, the buffer material 2 can be mounted on the lower plate 10 by coating or printing in the step of mounting a supporting structure 4 between the upper plate 12 and the lower plate 10.

As mentioned above, the supporting structure 4 close to the lower plate 10 is defined as the lower end 40 sticking on the buffer material 2. Correspondingly, the supporting structure 4 close to the upper plate 12 is defined as the upper end 42. Please refer to FIGS. 7 and 8 again. A step of pressing another buffer material 2 on the upper end 42 is further comprised after the step of forming a buffer material 2 connected to at least one of the upper plate 12, the lower plate 10 and the supporting structure 4. The supporting structure 4 is connected with the lower plate 10 through the buffer material 2 prior to the connection with the upper plate 12 therethrough. Therefore, a step is performed to solidify the buffer material 2 while the supporting structure 4 sticks with the lower plate 10. The solidifying step is further performed to make sure that the supporting structure 4 is combined with the upper plate 12 firmly, while the buffer material 2 exhibits its properties to connect with the supporting structure 4 and the upper plate 12. Certainly, the solidifying step is also performed to make the buffer material 2 simultaneously contacted with the lower end 40 and the upper end 42 after the supporting structure 4 is connected with the upper plate 12 and the lower plate 10. The way of solidifying is based on the properties of the buffer material 2 and can be achieved by heating, illuminating, and evaporation of the solvent of the buffer material 2.

Furthermore, a second predetermined area 120 is reserved without the fluorescent layer 3 on the upper plate 12 during the step of forming the fluorescent layer 3 on the upper plate 12, and the buffer material 2 is formed on the predetermined area 120. Certainly, the buffer material 2 is also formed within the predetermined area 120 before the upper plate 12 is connected with the supporting structure 4. As for forming the buffer material 2, it can be performed before or after the formation of the fluorescent material 3, or simultaneously. The way of forming the buffer material 2 may be one of coating, printing, and depositing, wherein the coating may be one selected from a dip coating, a roll coating, and a spray coating.

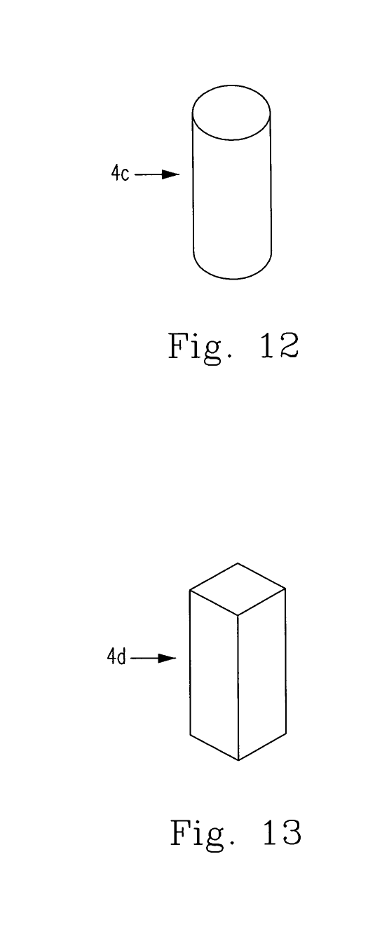

Please refer to FIG. 12, which shows a diagram of the protecting structure of the flat illuminating apparatus according to a preferred embodiment of the present invention. As shown in FIG. 12, the supporting structure 4c is a cylinder.

Please refer to FIG. 13, which shows a diagram of the protecting structure of the flat illuminating apparatus according to another preferred embodiment of the present invention. As shown in FIG. 13, the supporting structure 4d is rectangular.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims that are to be accorded with the broadest interpretation, so as to encompass all such modifications and similar structures. According, the invention is not limited by the disclosure, but instead its scope is to be determined entirely by reference to the following claims.

What is claimed is:

1. A flat illuminating apparatus, comprising:
a lower plate;
an upper plate opposing to the lower plate to form a containing space therebetween;
a supporting structure mounted within the containing space and connected with the upper and lower plate; and
a buffer material connected with at least one of the lower plate, the upper plate and the supporting structure.

2. The flat illuminating apparatus of claim 1, wherein the buffer material is formed between the supporting structure and the lower plate.

3. The flat illuminating apparatus of claim 1, wherein the buffer material is formed between the supporting structure and the upper plate to absorb an external force applied to the upper plate.

4. The flat illuminating apparatus of claim 1, further comprising a frame rimming the containing space.

5. The flat illuminating apparatus of claim 4, wherein the buffer material is formed between the frame and the upper plate and between the frame and the lower plate.

6. The flat illuminating apparatus of claim 1, further comprising:
a first electrode set connected with the lower plate and comprising a first subsidiary electrode and a second subsidiary electrode and a first spacing therebetween; and
a second electrode set connected with the lower plate and comprising a third subsidiary electrode and a fourth subsidiary electrode and a second spacing therebetween,
wherein the supporting structure is mounted respectively within the first and second spacing.

7. The flat illuminating apparatus of claim 1, further comprising:
a first electrode connected with the lower plate; and
a second electrode connected with the lower plate and forming a discharging zone and a non-discharging zone with the first electrode,
wherein the supporting structure is mounted in the non-discharging zone and the discharging zone has a discharging direction.

8. The flat illuminating apparatus of claim 7, wherein the first electrode comprises a first discharging part and a first conductive part; and
the second electrode comprises a second discharging part mounted corresponding to the first discharging part and a second conductive part mounted corresponding to the first conductive part,
wherein the discharging zone is formed by the first discharging part and the second discharging part, and the non-discharging zone is formed by the first conductive part and the second conductive part.

9. The flat illuminating apparatus of claim 7, wherein the supporting structure is a rectangular cylinder having a long side and a short side, and the long side is mounted along the discharging direction of the discharging zone.

10. The flat illuminating apparatus of claim 7, wherein the supporting structure is mounted respectively in the first and second electrodes.

11. The flat illuminating apparatus of claim 10, wherein the first electrode further comprises a first discharging part and a first conductive part connected with the supporting structure.

12. The flat illuminating apparatus according to claim 10, wherein the second electrode further comprises a second discharging part and a second conductive part connected with the supporting structure.

13. The flat illuminating apparatus according to claim 1, wherein the supporting structure tends to become gradually narrow along the direction from the lower plate to the upper plate.

14. The flat illuminating apparatus according to claim 1, wherein the supporting structure has a flat bottom and a cylinder is formed onto the flat bottom.

15. A method for manufacturing a flat illuminating apparatus, comprising following steps of:
(1) providing a lower plate and an upper plate;
(2) forming a layer of fluorescent material on the respective lower and upper plates;
(3) mounting a supporting structure between the upper plate and the lower plate;
(4) forming a buffer material connected to at least one of the upper plate, the lower plate and the supporting structure;
(5) solidifying the buffer material; and
(6) combining the upper plate, the supporting structure and the lower plate.

16. The method of claim 15, wherein the step (3) further comprises a step of pressing the supporting structure.

17. The method of claim 15, further comprising a step of mounting a frame between the upper and the lower plate.

18. The method of claim 15, wherein the supporting structure has a long side perpendicular to the lower plate.

19. The method of claim 15, wherein the step (2) is performed by one selected from the group consisting of coating, printing, and depositing.

20. The method of claim 19, wherein the coating is one selected from the group consisting of dip coating, roll coating, and spray coating.

21. The method of claim 15, wherein the step (4) is performed by coating and printing.

22. The method of claim 15, wherein a first predetermined area is further reserved without the layer of fluorescent material on the lower plate in the step (2), and the layer of buffer material is formed on the first predetermined area.

23. The method of claim 15, wherein the step (3) further comprises a step of coating the layer of buffer material between the upper plate and the supporting structure.

24. The method of claim 23, wherein a second predetermined area is further reserved without the layer of fluorescent material on the upper plate in the step (2), and the buffer material is coated on the second predetermined area.

25. The method of claim 24, further comprising a step of solidifying the buffer material between the upper plate and the supporting structure.
